(19) United States
(12) Patent Application Publication
(10) Pub. No.: US 2013/0198845 A1
(43) Pub. Date: Aug. 1, 2013

(54) MONITORING A WIRELESS NETWORK FOR A DISTRIBUTED DENIAL OF SERVICE ATTACK

(71) Applicant: Kiomars Anvari, Alamo, CA (US)

(72) Inventor: Kiomars Anvari, Alamo, CA (US)

(21) Appl. No.: 13/358,721

(22) Filed: Jan. 26, 2012

(51) Int. Cl. G06F 21/00

(52) U.S. Cl. 726/25

(57) ABSTRACT

An integrated circuit for monitoring a wireless network. The integrated circuit comprises a hardware interface configured to receive and access data packets transmitted over the wireless network; a programmable hardware accelerator configured to extract pertinent information from the data packets, the pertinent information for use in determining whether the wireless network is under a distributed denial of service (DDOS) attack; and a multi-core processor configured to receive the pertinent information and to determine whether the wireless network is under a DDOS attack based at least in part on the pertinent information provided by the programmable hardware.

### BACKGROUND

Typically, a cyber attack on service providers negatively affects the provided services to users. Oftentimes, a Distributed Denial of Service (DDOS) attack is directed towards a service provider to disrupt the services of the service provider. In general, a DDOS attack is an attempt to make a computer or network resource unavailable to its intended users. Although the means to carry out, motives for, and targets of a DDOS attack may vary, it generally consists of the concerted efforts of a person, or multiple people to prevent an Internet site or service from functioning efficiently.

A service provider may utilize conventional cyber attack protection, such as conventional monitoring or detection systems to protect from a DDOS attack. However, the conventional protection systems may not effectively protect from the DDOS attack. For example, the conventional monitoring or detections systems may be overwhelmed from the DDOS attack or may be slow in the monitoring/detecting. As a result, the DDOS attack may be successful and the services of the service provider are negatively affected.

### BRIEF DESCRIPTION OF THE DRAWINGS

FIG. 1 illustrates an embodiment of a wireless network.

FIGS. 2 and 3 illustrate embodiments of a system on a chip.

FIG. 4 illustrates embodiment s of a method for determining whether a wireless network is under a DDOS attack.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

As described above, a DDOS attack is directed towards a service provider to disrupt the services of the service provider. A DDOS attack may occur from multiple attack vectors (e.g., UDP, TCP, SYN, HTTP, etc.). The multiple attack vectors make it difficult for network DDOS tools to properly protect the network. Moreover, as the size and scope of an attack vector increases, the probability of at least one of the attack vectors being successful also increases. Additionally, it only requires one attack vector to be successful for the services to be disrupted. Accordingly, the mitigation of a DDOS attack from multiple vectors is very difficult to defend.

Conceptually, a DDOS attack may be partitioned in three layers. The three layers may be described as: (1) large volume flood attack layer, (2) large volume SYN flood layer, and (3) low and slow connection attack layer.

The first layer (e.g., the large volume flood attack layer or packet per second (PPS) attack) is directed towards the network. For example, this type of attack floods victims and consumes network and link capacity and resources. As a result, there is insufficient bandwidth for legitimate packets. A defense against the first layer attack may require the ability to process high volume packets and have the requisite bandwidth capacity such that a protection tool is not overloaded by the flood.

The second layer (e.g., the large volume SYN flood layer) is directed towards a server(s). For example, a connection or application flood attack (e.g., SYN flood, HTTP flood) is directed towards a server(s) of a service provider. In general, the second layer has a lower volume of attacks as compared with the first layer.

In the second layer attack, the transactions and connections are complete and legitimate connections. In particular, the attack is based or focused on the amount of connections. Moreover, the connections are generated by machines and/or non-legitimate users. A defense against the second layer attack may require correct and accurate identity of the malicious sources that are generating the legitimate or semi-legitimate transactions.

The third layer (e.g., low and slow connection attack layer) is directed towards applications. For example, a directed application DDOS attack may use different attack tools that send a low volume of packets (e.g., tens and hundreds of packets). A third layer attack exploits weaknesses in application implementation, such as a web implementation. The exploitation results in the exhaustion of application resources. A defense against the third layer attack may require a deep inspection and the need to add or create an ad-hoc filter on the fly.

It should be appreciated that successful mitigation of a DDOS attack may be rated or judged based on: the volume of attack traffic that is properly fended off, the number of legitimate users that are affected, and the time to properly monitor and detect a DDOS attack.

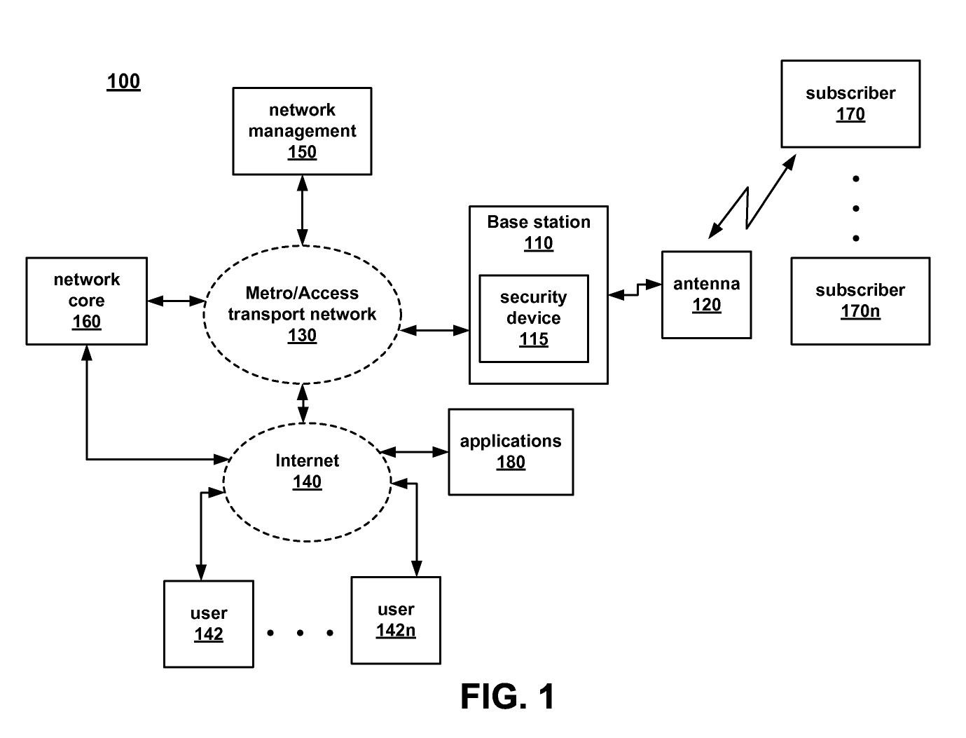

FIG. 1 depicts an embodiment of wireless network 100. In general, wireless network 100 facilitates in the providing of services, by a service provider, to subscribers (e.g., subscribers 170-170n) of the service provider. For example, subscribers 170-170n request services from the service provider. In response to the request, service provider provides the requested services to the users via wireless network 100. In various embodiments, the service provider provides services such, as but not limited to, telecommunication services, web base services (e.g., movies, banking, shopping, voice over IP (VOIP) etc.). It should be appreciated that wireless network 100 is packet based.

Wireless network 100 includes, among other things, base station 110, antenna 120, network management 150, network core 160, and applications 180.

In one embodiment, base station 110, antenna 120, network management 150, network core 160, and applications 180 are a network that belongs to the service provider and this network provides computation to the subscribers. For example, subscriber 170, through wireless network 100, utilizes applications 180 of the service provider. In various embodiments, applications 180 can be, but are not limited to, a data center, or an application center.

Base station 110 is for processing communications from subscribers to the service provider and vice versa via antenna 120. Base station 110 typically utilizes appropriate communications software and hardware to properly process the communications.

Antenna 120 can be any antenna that is able to wirelessly transmit/receive communication signals, such as data packets. Antenna 120 is disposed on any physical platform that is conducive to effectively transmit/receive the signals. For example, antenna 120 is disposed on a tower. It should be appreciated that many antennas may be disposed on the tower.

In various embodiments, all communication to and from the subscribers 170-170n passes through base station 110. For example, all legitimate or non-legitimate requests for services are received at base station 110 and subsequently transmitted to the service provider. For example, subscriber 170 requests a service from the service provider via a device, such as a cell phone, laptop, personal computer, etc. The service request is received by the service provider, in particular, at base station 110. Upon receipt, the service provider provides the requested services (in the form of data packets) which are sent to base station 110. In particular, subscriber receives the services (in the form of data packets) via base station 110 and antenna 120.

In one embodiment, communications through wireless network 100 are transmitted through metro/access transport network 130. Network 130 can be, but is not limited to, a Gigabit Ethernet network, or a 10-Gigabit Ethernet metropolitan access network. In general, metro/access transport network 130 is a transport network that covers a metropolitan area and based on the Ethernet standard. It is commonly used as a metropolitan access network to connect subscribers and businesses to a larger service network or the Internet (e.g., internet 140).

Network management 150 has a variety of functions. In general, network management 150 is utilized for activities, methods, procedures, and tools that pertain to the operation, administration, maintenance, and provisioning of networked systems. In one embodiment, network management 150 includes a database that is accessed by the service provider. The database can be utilized for analyzing statistics in real-time. Such statistics can be related to dropped packets.

Network core 160 also has a variety of functions, such as, but not limited to, authentication, authorization, accounting, tracking packets, client mobility management, etc. In general, network core 160 provides various services to customers who are connected by the access network. Moreover, network core 160 is a high capacity communication facility that connects primary nodes. Also, network core 160 provides paths for the exchange of information between different sub-networks.

In one embodiment, data packets go through network core 160. As such, network core 160 may be utilized for network protection. However, if data packets are not sent through network core 160, protection of network 100 may be more difficult to control.

The service provider may be susceptible to a DDOS attack which is propagated through wireless network 100. For example, a cyber criminal may initiate a DDOS attack against the service provider via internet 140. For example, users 142-142n utilize a client device to connect to and use internet 140. A cyber criminal may be one of the users and utilize his own computer to launch a DDOS attack against the service provider. Such an attack may be directed at base station 110.

The cyber criminal may gain control of one or more of the respective client devices of users 142-142n and utilize the one or more client devices to launch the DDOS attack against the service provider.

Although the service provider may implement conventional protection systems to defend against DDOS attacks, the conventional protection systems may not effectively defend against such an attack. For example, a base station utilizes hardware (e.g., a CPU) for monitoring/detection of a DDOS attack. However, the same hardware is also utilized for processing legitimate data packets such that they are properly transmitted. Thus, the conventional hardware in the base station is utilized for both cyber attack monitoring/detection and processing of legitimate data packets such that they are properly transmitted.

In some scenarios, such as low volume DDOS attacks, the conventional protection system may have the bandwidth and capacity to defend against the attacks. However, in other scenarios, such as a high volume DDOS attack, the conventional protection system does not have sufficient bandwidth and capacity to defend against the attacks. Accordingly, the DDOS attack is successful and services provided by the service provider are negatively affected.

In contrast, network 100 includes security device 115 that is designated solely for facilitating in the monitoring/detection of a cyber attack, in particular, a DDOS attack. In other words, security device 115 is not required to allocate CPU and/or memory resources to process legitimate communication traffic.

Security device 115 is implemented in base station 110. However, it should be appreciated that security device 115 may be implemented at other locations or accesses points within network 100.

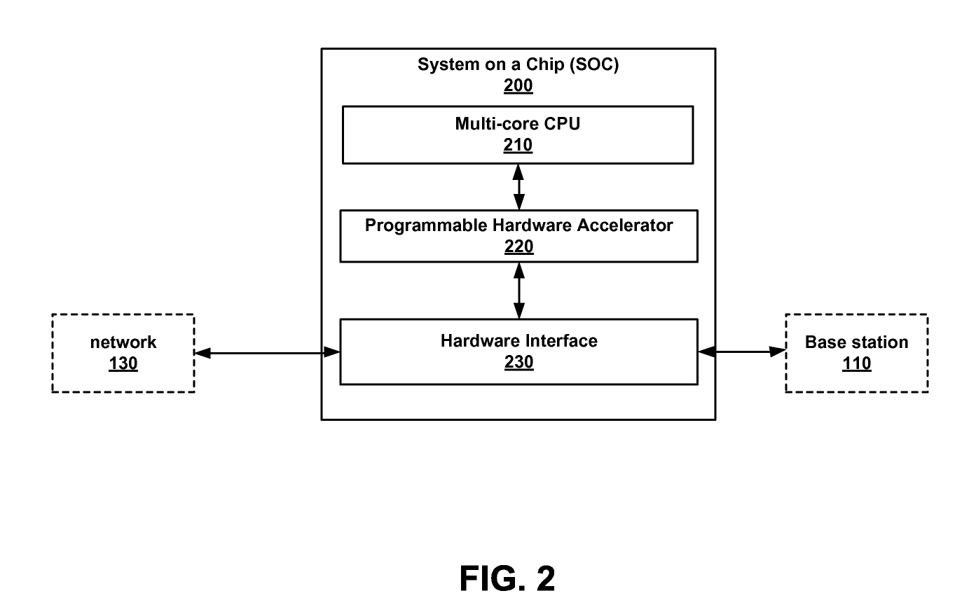

FIG. 2 depicts an embodiment of system on a chip (SOC) 200. In one embodiment, SOC 200 is security device 115 (as depicted in FIG. 1). In general, SOC 200 is configured for facilitating in the monitoring/detection of a DDOS attack in a wireless network. In particular, SOC 200 is able to process a high volume of data packets while having sufficient bandwidth capacity such that it is not overloaded by a DDOS attack, which will become more evident with further discussion below. In one embodiment, SOC 200 is capable of providing protection that requires bandwidth in the range of Giga Packets per Second (GPPS).

In one embodiment, SOC 200 is implemented in-line with base station 110. In another embodiment, a plurality of SOCs are disposed at various locations in network 100 for facilitating in the monitoring/detection of a DDOS attack. In various embodiments, SOC 200 (and functionality) are integrated to another SOC or a network on a chip (NOC) device.

SOC 200 includes CPU 210, programmable hardware accelerator 220, and hardware interface 230.

Hardware interface 230 is configured to receive and access data packets transmitted over the wireless network. For example, hardware interface 230 receives and accesses data packets from base station 110 or network 130 which are a part of wireless network 100. In various embodiments, hardware interface 230 is comprises a plurality of switches.

Programmable (or configurable) hardware accelerator 220 is configured to extract pertinent information from the data packets, which are broadcasted to the programmable hardware accelerator 220 by hardware interface 230. The pertinent information is utilized in determining whether a wireless network is under a DDOS attack. In general, pertinent information is obtained by extracting out important information from the data packets and/or removing extraneous information from the data packets. In one embodiment, programmable hardware accelerator 220 is an FPGA.

Multi-core CPU 210 is configured to receive the pertinent information and to determine whether the wireless network is under a DDOS attack based at least in part on the pertinent information provided by the programmable hardware. For example, multi-core CPU 210 executes an algorithm (e.g., a DDOS attack determination algorithm) that utilizes the pertinent information to determine whether or not network 100 is under a DDOS attack. In various embodiments, multi-core CPU 210 is a plurality of multi-core CPUs.

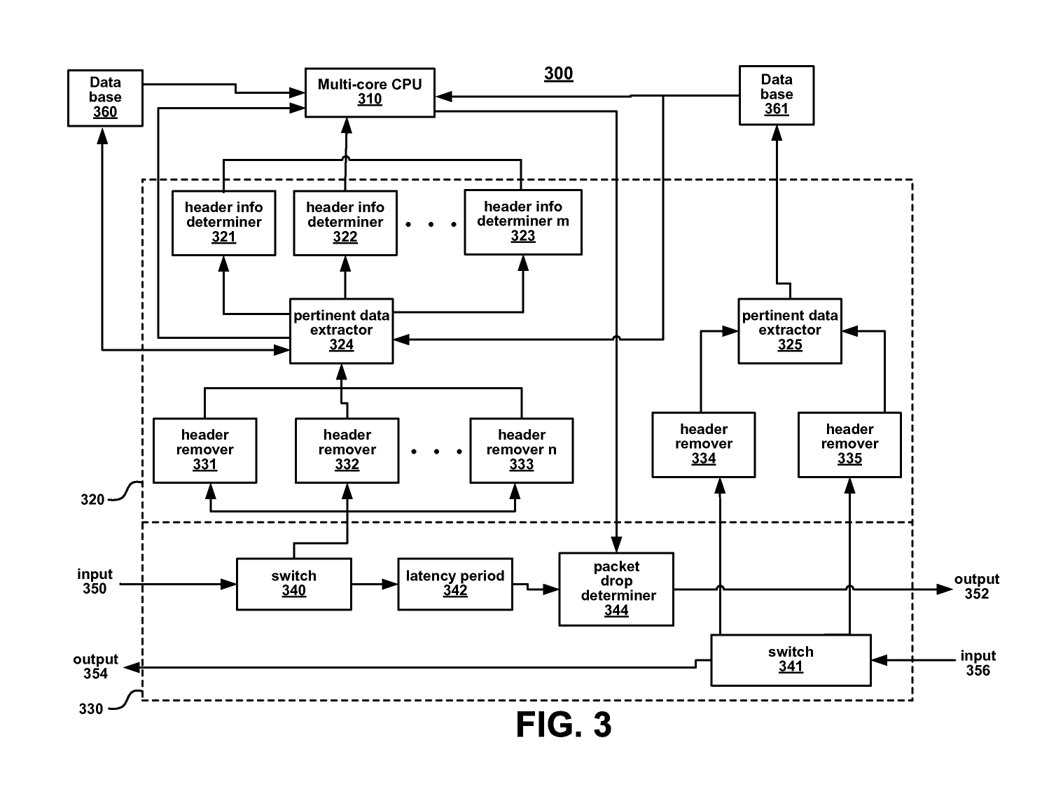

FIG. 3 depicts an embodiment of SOC 300. In one embodiment, SOC 300 is similar to SOC 200. For instance, SOC 300 includes hardware interface 330, programmable hardware accelerator 320, and multi-core CPU 310, similar to SOC 200.

Hardware interface 330 includes switch 340, packet drop determiner 344 and switch 341. During use of SOC 300, switch 340 receives and accesses input 350. In one embodiment, input 350 are data packets intended to be transmitted to a subscriber via base station 210.

When input 350 is received at interface 330, in particular, at switch 340, it is unclear whether input 350 is a DDOS attack. Accordingly, SOC 300 extracts pertinent information from input 350 such that multi-core CPU 310 is able to determine whether input 350 is a DDOS attack.

In general, if it is determined that a data packet of input 350 is not a DDOS attack, then the data packet is transmitted to a subscriber as output 352. In contrast, if it is determined that a data packet of input 350 is a DDOS attack, then the data packet is dropped and not transmitted to the subscriber.

Switch 340 concurrently broadcasts a data packet of input 350 to each of the header removers (e.g., header removers 331-333).

Header removers 331-333 are configured to remove the Layer 2 header from the data packet. It should be appreciated that network 100 may support n different types of protocols, therefore, there may be n different types of Layer 2 headers associated with input 350. Therefore, there are n different header removers each corresponding to the n different types of Layer 2 headers. For example, if there are five different types of protocols supported by network 100, then the Layer 2 header of each data packet may be one of five different possible types of Layer 2 headers. Accordingly, there are five different header removers associated with each of the five different types of Layer 2 headers. In other words, when a data packet is broadcasted to each of the header removers, only one of the header removers matches up with the corresponding Layer 2 header, while the other header removes do not match up with the Layer 2 header of the received data packet.

Once the Layer 2 header is removed from the data packet, the data packet is transmitted (by the corresponding Layer 2 header remover) to pertinent data extractor 324. In general, pertinent data extractor 324 is configured to extract pertinent data from the data packet. Pertinent data can be, but is not limited to, IP address and data protocol type. Moreover, pertinent data extractor 324 removes the Layer 3 header from the data packet.

Additionally, the extracted IP address (e.g., source and/or destination IP address) is transmitted to data base 360 (from pertinent data extractor 324) to facilitate in determining whether there is a DDOS attack. In one embodiment, the source IP address of the packet (from input 350) is stored in data base 360 to facilitate in determining whether there is a DDOS attack, which will be described in further detail below.

Pertinent data extractor 324 concurrently broadcasts the data packet to header information determiners 321-323. The header information determiners are configured to determine Layer 4 header information of the data packet based on a data protocol type of the data packet.

It should be appreciated that the data packet may include one of m different types of data protocols. Therefore, there are m different header information determiners each corresponding to m different types of data protocols. For example, if there are five different possible types of data protocols, then the data protocol type of each data packet may be one of the five different possible types of data protocols. Accordingly, there are five different header information determiners associated with each of the five different types of data protocols. In other words, when a data packet is broadcasted to each of the header information determiners, only one of the header information determiners matches up with the corresponding data protocol type of the data packet, while the other header information determiners do not match up with the data protocol type of the received data packet.

Once the Layer 4 header information of the data packet is determined, the Layer 4 header information is transmitted (by the corresponding header information determiner) to CPU 310.

Accordingly, multi-core CPU 310 executes an algorithm (e.g., a DDOS attack determination algorithm) that utilizes the pertinent information (e.g., the Layer 4 header information) to determine whether network 100 is under a DDOS attack.

If multi-core CPU 310 determines that the data packet is not a DDOS attack, then the determination is transmitted to packet drop determiner 344 to direct packet drop determiner 344 to forward the particular data packet. For example, the particular data packet is transmitted as output 352 to base station 110, such that base station 110 processes and transmits the data packet to a subscriber of the service provider.

In contrast, if multi-core CPU 310 determines that the data packet is a DDOS attack, then the determination is transmitted to packet drop determiner 344 to direct packet drop determiner 344 to drop the particular data packet. For example, the particular data packet is dropped and not transmitted to base station 110.

Latency period 342 is the acceptable time period of transmitting the data packets to base station 110 once the data packets are received at switch 340. Latency period 342 is configurable based on a Service Level Agreement (SLA) and/or a Quality of Service (QoS). In various embodiments, latency period 342 is in the range of a few seconds to a fraction of a second.

It should be appreciated that the period of time for SOC 300 to receive a data packet and determine whether it is a DDOS attack is within the latency period 342. Accordingly, SOC 300 is able to determine whether a received data packet is a DDOS attack in the range of a few seconds to a fraction of a second. In one embodiment, SOC 300 is able to determine whether a received data packet is a DDOS attack in real-time (or near real-time). It should be appreciated that the time frame should be as short as possible such that the services (e.g., website) of service provider will be available for use as long as possible during a DDOS attack.

In various embodiments, SOC 300 utilizes additional information to facilitate in determining whether input 350 is a DDOS attack. For instance, service provider provides services to a subscriber (e.g., subscriber 170) in response to a request from the subscriber.

The request for service is transmitted as input 356 (e.g. data packets) to switch 341 after being processed by base station 110. Input 356 is thus utilized to facilitate in determining if there is a DDOS attack.

It should be appreciated that input 356, from the subscribers, is assumed to be legitimate and not a source of a DDOS attack because attacks typically don't come from subscribers who need and use the services of the service provider. In particular, source and destination IP address of input 356, from the subscriber, is assumed to be legitimate and correct.

Switch 341 is similar to switch 340. As such, switch 341 concurrently broadcasts the data packet of input 356 to header removers 334 and 335. Moreover, switch 341 transmits input 356 from the subscriber as output 354 to the service provider.

Although two header removers 334 and 335 are shown, it should be appreciated that the number of header removers for removing Layer 2 headers from input 356 corresponds to the number of different types of Layer 2 headers that are supported by base station 110.

Header removers 334 or 335 remove the Layer 2 header from the received data packet.

Once the Layer 2 header is removed from the data packet, the data packet is transmitted (by the corresponding Layer 2 header remover) to pertinent data extractor 325. Pertinent data can be, but is not limited to, source and/or destination IP address and data protocol type. Moreover, pertinent data extractor 325 removes the Layer 3 header from the data packet. In particular, the extracted IP address is transmitted to data base 361 (from pertinent data extractor 325) to facilitate in determining whether there is a DDOS attack.

In one embodiment, the destination IP address of the packet (from input 356) is stored in data base 361 to facilitate in determining whether there is a DDOS attack, which will be described in further detail below.

The IP addresses stored in the data bases can facilitate in determining what subscribers or illegitimate users have been contacting service provider. For example, a destination IP address of a data packet of input 356 (e.g., from subscriber 170), which is stored in data base 361, can be compared with a source IP address of an associated data packet of input 350, which is stored in data base 360.

If one of the destination IP addresses of data base 360 is the same as the source address of the data packet of input 350, then it can be determined that the particular data packet of input 350 is legitimate and not a DDOS attack. In one embodiment, this information can be determined at programmable hardware accelerators 320 and transmitted to multi-core CPU 310.

If one of the destination IP addresses of input 356, stored in data base 361, is different than the source address of the data packet of input 350, stored in data base 360, then it can be a presumed that the particular data packet of input 350 is not legitimate and a possible DDOS attack. As such, the particular data packet of input 350 can be examined further to determine if it is a DDOS attack. In one embodiment, this information can be determined at programmable hardware accelerators 320 and transmitted to multi-core CPU 310.

In one embodiment, SOC 300 is able to perform and identify malicious sources using, among other things, signatures, real-time signatures, and on-the-fly signatures.

In another embodiment, SOC 300 is able to perform a full 10G deep inspection processing (DPI) and/or an infected regular expression (RegEx) filtering on traffic, when the majority of the traffic is legitimate traffic and there is not a need to perform string searches and RegEx searches on the high volume traffic without impacting the performance of the traffic.

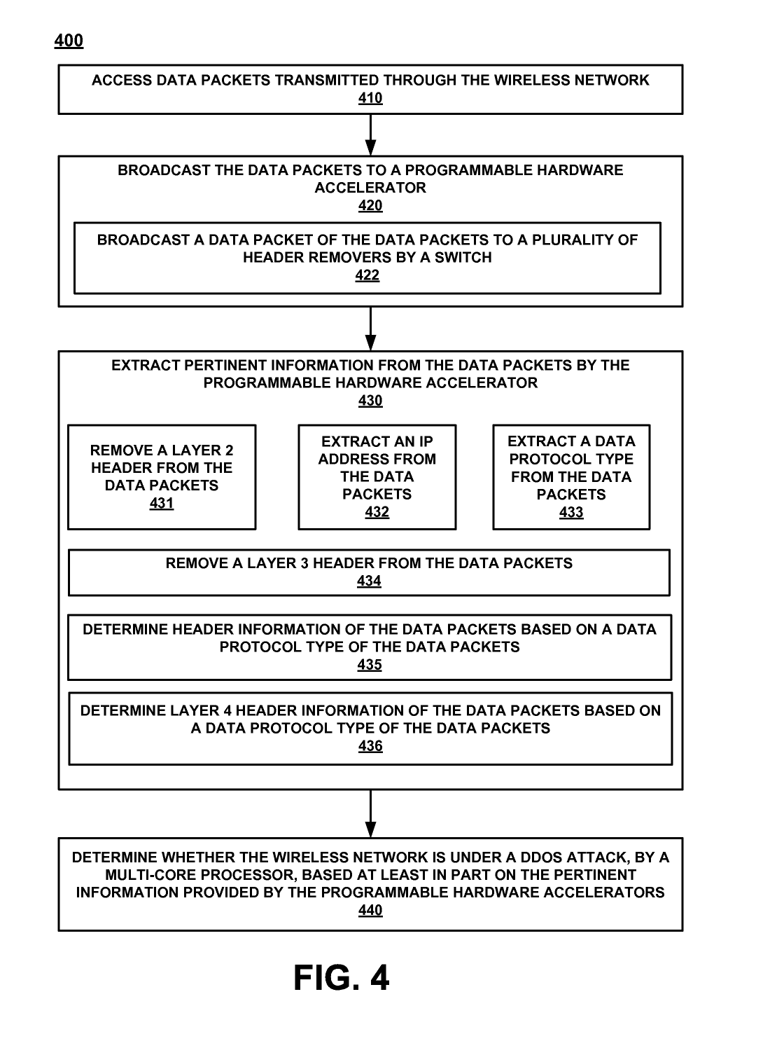

FIG. 4 depicts an embodiment of method 400 for determining whether a wireless network is under a DDOS attack. In various embodiments, method 400 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 400 is performed at least by SOCs 200 and 300.

At 410 of method 400, data packets transmitted through the wireless network are accessed. For example, a series of data packets (e.g. input 350) transmitted through network 100 are accessed by switch 340.

At 420, the data packets are broadcasted to a programmable hardware accelerator. For example, the data packets are broadcasted to header removers 331-333 from switch 340.

In one embodiment, at 422, a data packet of the data packets is broadcasted to a plurality of header removers by a switch. For example, each data packet, in succession, is broadcasted concurrently to header removers 331-333 by switch 340.

At 430, pertinent information from the data packets is extracted by the programmable hardware accelerator. For example, programmable hardware accelerator 320 extracts pertinent information that is subsequently utilized to facilitate in determining whether the data packets are a part of a DDOS attack.

In one embodiment, at 431, a Layer 2 header is removed from the data packets. For example, the data packet received by header removers 331-333 has its Layer 2 header removed by the header remover that corresponds to the particular Layer 2 header of the data packet.

In another embodiment, at 432, an IP address is extracted from the data packets. For example, pertinent data extractor 324 extracts a source IP address from the data packet received from one of the header removers.

In a further embodiment, at 433, a data protocol type is extracted from the data packets. For example, pertinent data extractor 324 extracts a data protocol type from the data packet received from one of the header removers.

In yet another embodiment, at 434, a Layer 3 header is removed from the data packets. For example, pertinent data extractor 324 removes the Layer 3 header from the data packet received from one of the header removers.

In one embodiment, at 435, header information of the data packets is determined based on a data protocol type of the data packets. For example, one of the header information determiners 321-323 determines the header information of the data packet based on the data protocol type. Header information can be, but is not limited to, UDP flood, SYN flood, TCP flood.

In another embodiment, at 436, Layer 4 header information of the data packets is determined based on a data protocol type of the data packets. For example, one of the header information determiners 321-323 determines the header information of the data packet based on the data protocol type.

At 440, it is determined, by a multi-core processor, whether the wireless network is under a DDOS attack, based at least in part on the pertinent information provided by the programmable hardware accelerator. For example, multi-core CPU 310 determines whether wireless network 100 is under a DDOS attack. The determination is based, at least in part, on the pertinent information (e.g., Layer 4 header information) extracted by programmable hardware accelerator 320.

Various embodiments are thus described. While particular embodiments have been described, it should be appreciated that the embodiments should not be construed as limited by such description, but rather construed according to the following claims.

1. An integrated circuit for monitoring a wireless network, said integrated circuit comprising:
a hardware interface configured to receive and access data packets transmitted over said wireless network;
a programmable hardware accelerator configured to extract pertinent information from said data packets, said pertinent information for use in determining whether said wireless network is under a distributed denial of service (DDOS) attack; and
a multi-core processor configured to receive said pertinent information and to determine whether said wireless network is under a DDOS attack based at least in part on said pertinent information provided by said programmable hardware.

2. The integrated circuit of claim 1, wherein said integrated circuit is a system on a chip (SOC).

3. The integrated circuit of claim 2, wherein said SOC is integrated in another SOC or integrated in a network on a chip (NOC).

4. The integrated circuit of claim 1, wherein said integrated circuit is disposed in a base station of said wireless network.

5. The integrated circuit of claim 1, wherein said hardware interface comprises a switch configured to broadcast said data packets to said programmable hardware accelerator.

6. The integrated circuit of claim 1, wherein said programmable hardware accelerator further comprises:
a plurality of header removers configured to remove a Layer 2 header from said data packets.

7. The integrated circuit of claim 1, wherein said programmable hardware accelerator further comprises:
a pertinent data extractor configured to extract an IP address and a data protocol type from said data packets.

8. The integrated circuit of claim 7, wherein said pertinent data extractor is further configured to remove a Layer 3 header from said data packets.

9. The integrated circuit of claim 1, wherein said programmable hardware accelerator further comprises:
a plurality of header information determiners configured to determine header information of said data packets based on a data protocol type of said data packets.

10. The integrated circuit of claim 1, wherein said programmable hardware accelerator further comprises:
a plurality of header information determiners configured to determine Layer 4 header information of said data packets based on a data protocol type of said data packets.

11. A method for determining whether a wireless network is under a distributed denial of service (DDOS) attack, said method comprising:
accessing data packets transmitted through said wireless network;
broadcasting said data packets to a programmable hardware accelerator;
extracting pertinent information from said data packets by said programmable hardware accelerator;
providing said pertinent information to a multi-core processor from said programmable hardware accelerator; and
determining whether said wireless network is under a DDOS attack based at least in part on said pertinent information provided by said programmable hardware accelerators.

12. The method of claim 11, wherein said broadcasting said data packets to a programmable hardware accelerator further comprises:
broadcasting a data packet of said data packets to a plurality of header removers by a switch.

13. The method of claim 11, wherein said extracting pertinent information from said data packets by said programmable hardware accelerator further comprises:
removing a Layer 2 header from said data packets.

14. The method of claim 11, wherein said extracting pertinent information from said data packets by said programmable hardware accelerator further comprises:
extracting an IP address from said data packets.

15. The method of claim 11, wherein said extracting pertinent information from said data packets by said programmable hardware accelerator further comprises:
extracting a data protocol type from said data packets.

16. The method of claim 11, wherein said extracting pertinent information from said data packets by said programmable hardware accelerator further comprises:
removing a Layer 3 header from said data packets.

17. The method of claim 11, wherein said extracting pertinent information from said data packets by said programmable hardware accelerator further comprises:
determining header information of said data packets based on a data protocol type of said data packets.

18. The method of claim 11, wherein said extracting pertinent information from said data packets by said programmable hardware accelerator further comprises:
determining Layer 4 header information of said data packets based on a data protocol type of said data packets.

19. A system on a chip for monitoring a wireless network, said system on a chip comprising:
a data packet broadcasting means for broadcasting data packets transmitted over said wireless network;
a pertinent information extracting means for extracting pertinent information from said broadcasted data packets; and
a distributed denial of service (DDOS) attack determination means for determining whether said wireless network is under a DDOS attack based at least in part on said pertinent information.

20. The system on a chip of claim 19, further comprising:
a header removing means for removing one or more of a Layer 2 and Layer 3 header from said data packets.
